(19) United States
(12) Patent Application Publication
(10) Pub. No.: US 2026/0080459 A1
(43) Pub. Date: Mar. 19, 2026

(54) SYSTEMS AND METHODS FOR PERSONALIZED VIRTUAL TRY ON

(71) Applicant: ELC MANAGEMENT LLC, Melville, NY (US)

(72) Inventor: Christopher Aidan, Austin, TX (US)

(21) Appl. No.: 18/890,323

(22) Filed: Sep. 19, 2024

(51) Int. Cl. G06Q 30/0601

(52) U.S. Cl. CPC G06Q 30/0643

(57) ABSTRACT

Techniques for a user to virtually try-on a physical wearable item at a physical location include detecting the physical presence of a wearable item and identifying a user to automatically trigger virtual try-on of the detected item on the user. Waypoints of a digital/virtual representation of the item may be mapped to waypoints of a virtual mapping or 3D mesh of the user, where the item's digital/virtual representation and/or the user's mapping/3D mesh may be generated in-line with the detecting of the physical wearable item. An AR representation of the wearable item being worn by the user may be generated and presented on image(s) of the user within the physical location. The user may make adjustments (e.g. to the wearable item and/or to the user's appearance) during the virtual try-on, and the techniques may indicate other wearable item(s) which are customized for the user based on the AR representation.

### CROSS-REFERENCE TO RELATED APPLICATIONS

This application is related to U.S. patent application Ser. No. 18/748,856 entitled “Accurate Cosmetic Application Through Advanced Facial Mapping” and filed on Jun. 20, 2024, the disclosure of which is incorporated herein by reference in its entirety.

### FIELD OF THE DISCLOSURE

The present disclosure relates generally to providing individualized personalization of virtual try on of wearable items such as clothing, jewelry, and accessories.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Online shopping and digital commerce have drastically transformed the way consumers purchase goods. However, these platforms have traditionally lacked the personal touch and interactivity of physical retail, particularly the ability for a person to ‘try on’ products before purchasing to see how the products appear on the person while the wearing them. Similarly, in physical retail stores, a person physically trying on multiple products can be time-consuming and inconvenient. Furthermore, the ongoing global circumstances have accelerated the need for safe and contactless shopping experiences, both online and in physical stores.

Current techniques for digitally displaying how a wearable item would look when being worn by a person are typically implemented in a virtual environment (e.g., via a website, a an application on a smart device, etc.) and may include, for example, a user selecting a virtual model or avatar and having a digital image of an item being displayed on the virtual model or avatar. Other current digital display techniques, such as those which apply filters to social media images, merely overlay a depiction of an item on top of an image of a user. However, there is still a need for a system that allows consumers to virtually try on products in a realistic, more customized and/or personalized (e.g., individualized) manner, and that particularly enhances physical, in-store shopping or other physical enterprise experiences.

### SUMMARY

Techniques, systems, apparatuses, components, devices, and methods that allow a person to virtually try on one or more wearable items (e.g., such as clothing, jewelry, accessories, etc.) with a high degree of realism, e.g., in a manner that is customized or personalized specifically for the particular person (e.g., that is individualized for the particular person and with a high degree of realism), are disclosed. Generally speaking, the techniques described herein may detect or otherwise identify the physical presence of a wearable item within a physical enterprise environment or location, as well as detect or otherwise identify a particular user on which the detected physical wearable item is to be virtually tried-on. That is, both the detection of the physical wearable item and the identification of the user may automatically trigger virtual try-on of the detected physical wearable item on the user in a customized (and sometimes unique) manner. For example, the techniques may, based on the detection and identification, may assign waypoints of a digital representation of the wearable item to waypoints of a virtual mapping or three-dimensional (3D) mesh, where the virtual mapping or 3D mesh represents an appearance of a user who wants to virtually try on the wearable item. The virtual mapping or 3D mesh of the appearance of the user may be generated, for example, from image data of one or more digital images of the user, where the one or more digital images of the user may include stored images and/or images obtained in real-time. For example, in one implementation, the virtual mapping or 3D mesh of the appearance of at least some portion of the user (e.g., the user's face, neck, head, torso, entire body, etc.) may be generated by using any one or more mapping techniques described in U.S. patent application Ser. No. 18/748,856 entitled “Accurate Cosmetic Application Through Advanced Facial Mapping” and filed on Jun. 20, 2024, the disclosure of which is incorporated herein by reference in its entirety. Generally speaking, such virtual mappings or 3D meshes do not merely use simple edge or feature detection techniques to detect various features of a person (such as the person's eyes, nose, mouth, shoulders, etc.) within an image, but utilize more customized, individualized techniques.

At any rate, the techniques disclosed herein may also generate, based on the assignment of the waypoints, an augmented reality (AR) representation of the wearable item being worn by the user, and the techniques may present the AR representation on one or more images of the user on a display which is also disposed at the physical enterprise environment or location. In such a manner, rather than merely and crudely representing the user with a generic avatar or overlaying a digital representation of the wearable item on an image of the user (e.g., based on edge detection), the AR representation is customized or personalized for the user based on waypoints that are specific (and in some cases, unique) to the user based on the individual mapping or 3D mesh of the user's appearance. As such, due to the customization or personalization on an individual basis, the AR representation of a wearable item on a first user would differ from the AR representation of the wearable item on a second user having a similar build, size, and coloring of the first user.

Such AR representations may be presented on displays disposed within physical enterprise environments or locations. For example, with at least some of the novel and inventive techniques described herein, a person may be able to bring a garment to a smart mirror disposed at a physical location of an enterprise (e.g., retail store, big box store, summer festival, pop-up retail location, fashion show, garage or yard sale, etc.), sensors which are fixedly disposed at the physical location may detect the presence of the garment, and an AR representation of the person wearing the garment may be presented on the smart mirror (e.g., on a display of the smart mirror) without the person needing to find an empty dressing room, disrobe, etc. In another example, a person may be attending a live fashion show and have a smart device or phone on which an application which supports at least some of the novel and inventive techniques described herein is executing. During the fashion show, the application may detect the presence of a dress of a new collection of a fashion designer while a model wearing the dress walks down the runway past the person, and an AR representation of the person operating the smart device (or another person indicated by the person operating the smart device) wearing the dress may be presented in real-time on the screen of the person's smart device or phone. In some situations, for dynamic images (e.g., real-time videos) of the user, as movements of the user are displayed, the corresponding behavior of the wearable item on the user as depicted by the AR representation are also displayed as if the user were physically wearing the item during the movements. Additionally, the user may indicate one or more adjustments to the AR representation (such as, for example, a different sized garment; a different colored garment; alterations to the garment such as hem length, sleeve length, etc.; additional accessories in combination with the garment (which may have also been detected by the sensors); and the like). The application may adjust the AR representation according to the indicated adjustment(s) and present the adjusted AR representation on the person's image.

In an embodiment, an augmented reality (AR) system may include one or more sensors disposed at a physical enterprise location, one or more processors, and one or more non-transitory memories coupled to the one or more processors and storing computer-executable instructions. The computer-executable instructions, when executed by the one or more processors, may cause the AR system to detect, via the one or more sensors, an indication of a physical presence of a wearable item at the physical enterprise location; based on the detection, obtain a virtual depiction of the wearable item; and obtain a virtual mapping of at least a portion of an appearance of a user. The computer-executable instructions may be further executable to cause the AR system to assign one or more waypoints of a plurality of waypoints of the virtual depiction of the wearable item to respective waypoints of a plurality of waypoints of the virtual mapping corresponding to the user, and based on the assignment, generate an AR representation of the wearable item on the user. Additionally, the computer-executable instructions may be further executable to cause the AR system to present, at a display disposed at the physical enterprise location, the AR representation on one or more images of the user.

In an embodiment, a method at an augmented reality (AR) system may include detecting, via one or more sensors disposed at a physical enterprise location and by one or more processors of the AR system, an indication of a physical presence of a wearable item, and responsive to the detecting, obtaining, by the one or more processors, a virtual depiction of the wearable item. The method may additionally include obtaining, by the one or more processors, a virtual mapping of at least a portion of an appearance of a user; assigning, by the one or more processors, one or more waypoints of a plurality of waypoints of the virtual depiction of the wearable item to respective waypoints of a plurality of waypoints of the virtual mapping corresponding to the user; generating, based on the assigning and by the one or more processors, an AR representation of the wearable item on the user; and presenting, at a display disposed at the physical enterprise location and by the one or more processors, the AR representation on one or more images of the user.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

FIG. 1 depicts an exemplary system for providing customized or personalized virtual try-on of a wearable item.

FIG. 2 is a flow diagram of an exemplary computer-implemented method for customized or personalized virtual try on.

FIG. 3 depicts a flow chart of an example method for creating, generating, or updating one or more machine learning models for providing customized or personalized virtual try-on of a wearable item.

While the systems and methods disclosed herein is susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Example System

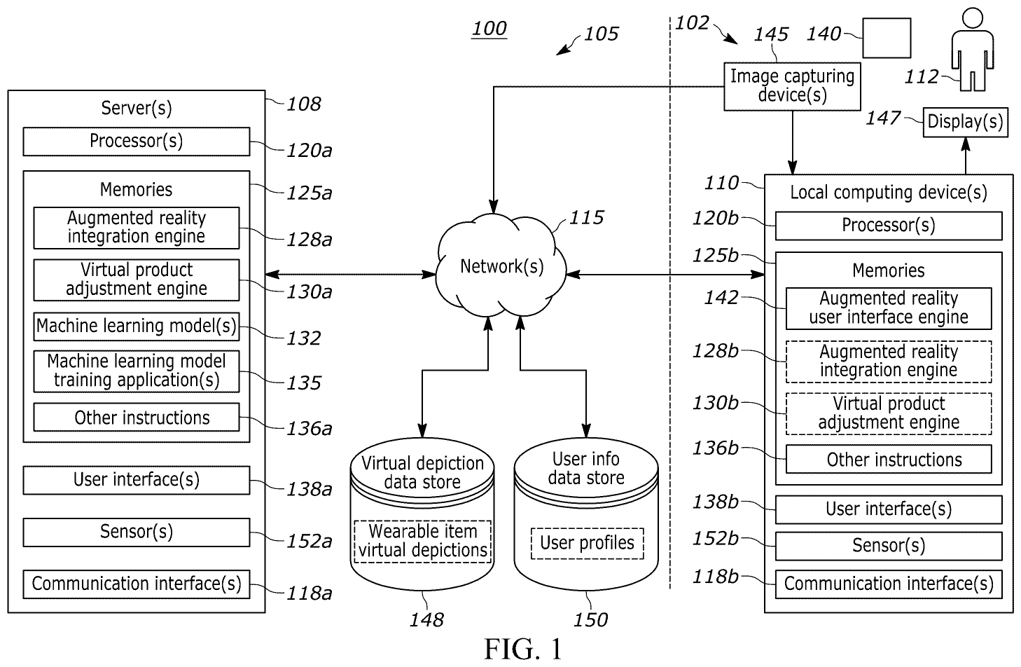

FIG. 1 depicts an example system 100 that provides customized or personalized virtual-try on of a wearable item, e.g., at a physical location of an enterprise which provides the wearable item. The system 100 is interchangeably referred to herein as the “Augmented Reality system 100,” the “AR system 100,” or the “system 100.” As shown in FIG. 1, at least a portion of the system 100 may be disposed in or at a physical or front-end enterprise environment or location 102, and at least a portion of the system 100 may be disposed in a back-end or remote environment 105. The example system 100 includes one or more servers 108 disposed in the back-end environment 105 and one or more local computing devices 110 disposed in the physical enterprise environment 102, where at least some of the local computing devices 110 may or may not be operated by a user 112 (e.g., a person who wishes to virtually try-on a wearable item or an agent of the enterprise). For example, the one or more local computing devices 110 may include a personal electronic device (PED) of the user 112 (such as a smart device, tablet, cell phone, etc.) or a kiosk operated by the user 112, and/or one or more local computing devices 110 may be include a computing device 110 which is disposed at the physical enterprise environment 102 and which is owned by and/or operated by the enterprise without utilizing any input of the user 112 at all. The one or more servers 108 and the local computing device(s) 110 may be communicatively connected via one or more networks 115 and respective communication interfaces 118a, 118b. The one or more networks 115 may be implemented via only a single communication link directly connecting the one or more servers 108 and the local computing device(s) 110 (e.g., a direct wireless or wired link), or one or more networks 115 may include multiple links, data networks, and/or communication networks of one or more types (e.g., one or more wired and/or wireless local area networks (LANs), and/or one or more wired and/or wireless wide area networks (WANs) such as the Internet, public networks, private networks, etc.). As such, the communication interfaces 118a, 118b may include respective one or more transceivers and other hardware, firmware, and/or software that is generally configured to communicate with other devices (which may include mobile devices) over the network 115 using one or more wireless communication protocols. For example, the communication interfaces 118a, 118b may be respectively configured to transmit and receive data using a Bluetooth protocol, a Wi-Fi® (IEEE 802.11 standard) protocol, a near-field communication (NFC) protocol, a cellular (e.g., GSM, CDMA, LTE, WiMAX, etc.) protocol, a peer-to-peer wireless protocol, a short-range wireless protocol, and/or other suitable wireless communication protocols. In some implementations, communication interfaces 118a, 118b may include respective one or more wired communication interfaces which may be utilized by the server 108 or the local computing device(s) 110 to communicatively connect to the network 115 and/or to other devices via one or more wired communications or data protocols. For ease of reading herein and not for limitation purposes, the one or more servers 108, the one or more local computing devices 110, the one or more networks 115, and the one or more communication interfaces 118a, 118b may be referred to herein using the singular tense.

As depicted in FIG. 1, the server 108 of the system 100 may include one or more processors 120a and one or more tangible, non-transitory memories 125a. Generally, the one or more servers 108 may include, for example, one or more local and/or remote servers, a bank or group (e.g., cluster or cloud) of servers, and/or one or more other suitable types of computing devices and/or computing systems. The one or more processors 120a may include any suitable number of processors and/or processor types (e.g., one or more central processing units (CPUs)). Processor 120a may include one or more CPUs and one or more graphics processing units (GPUs), for example. Generally, processor 120a is configured to execute software and/or other types of computer-executable instructions stored in the one or more memories 125a, such as the augmented reality integration engine 128a, the virtual product adjustment engine 130a, one or more machine learning (ML) models 132 (which may include one or more machine-learning algorithms) and/or one or more machine learning model training applications 135 as depicted in FIG. 1, and/or other sets of computer-executable instructions 1356a. The one or more memories 125a may be implemented by any suitable one or more persistent memories, such as Random Access Memories (RAMs), Read-Only Memories (ROMs), flash memory, hard drives, solid state memories, data banks, cloud data storage, and/or other types of persistent memories. In some implementations, the memories 125a may include one or more memories that are located remotely from the system 100 (e.g., remote data banks, etc.). For ease of reading herein and not for limitation purposes, the one or more processors 120a and the one or more memories 125a may be referred to herein using the singular tense.

As mentioned above, the memories 125a may store an augmented reality integration engine 128a, a virtual product adjustment engine 130a, one or more ML models 132, and one or more ML model training engines 135. Each of the augmented reality integration engine 128a, the virtual product adjustment engine 130a, the one or more machine learning (ML) models 132, and the ML model training engine 135 may include respective computer-executable instructions which, when executed by the one or more processors 120a, may cause the system 100 to implement one or more of the techniques described elsewhere herein. Further, although the augmented reality integration engine 128a, the virtual product adjustment engine 130a, the one or more machine learning (ML) models 132, and the one or more ML model training engines 135 are depicted in FIG. 1 as being separate sets of modules or computer-executable instructions, this is for clarity of discussion purposes only, and is not meant to be limiting. Indeed, in implementations one or more of the augmented reality integration engine 128a, the virtual product adjustment engine 130a, the one or more machine learning (ML) models 132, and the one or more ML model training engines 135 may be implemented as an integral set of computer-executable instructions or as an integral module. Training engines 135 may utilize supervised and/or unsupervised training techniques, for example.

The server 108 may additionally include one or more user interfaces 138a. The one or more user interfaces 138a may include one or more suitable types of user input devices, such as integrated and/or external keyboards, touch screen displays, microphones, touch pads, mice, and/or any suitable types of remote and/or local user input devices, along with associated software and/or firmware. The one or more user interfaces 138a may include one or suitable types of output devices, such as displays (which may include touch screen displays), speakers, and the like, along with associated software and/or firmware. For example, one or more of the user interfaces 138a may be respectively integrated with a display of a smart mirror, a mobile computing device, or another suitable computing device. The one or more user interfaces 138a may include one or more local interfaces (e.g., with respect to the back-end environment 105), and/or may include one or more remote interfaces 138b (e.g., with respect to the back-end environment 105) that are communicatively connected to the server 108 via the network 115 (e.g., that are provided by an application, client, web browser, or other software executing on a personal electronic device (PED), laptop, tablet, or other remote computing device 110). For ease of reading (and not limitation) purposes, the one or more user interface(s) 138a, 138b may be referred to herein using the singular tense.

Generally speaking, and as will be described in more detail elsewhere herein, the augmented reality integration engine 128a may execute or operate to detect the presence (e.g., the physical presence) of a wearable item 140 located in the physical environment 102 of the enterprise, obtain a virtual depiction of the wearable item 140 and a virtual mapping or 3D mesh of at least some part of an appearance of a user 112 (e.g., face, torso, entire body, etc.), integrate the virtual depiction and the virtual mapping/3D mesh into an AR representation of the wearable item 140 being worn by the user 112, and cause the AR representation to be presented on a display 147 and/or user interface 138b disposed within the physical environment 102. That is, the augmented reality integration engine 128a may generate the AR representation of the wearable item 140 being worn by the user 112 based on a detection of the presence of the wearable item 140, e.g., within the physical environment 102. The AR representation may be presented on an image of the user 112 which is being presented on a display 147 and/or on a user interface 138b, for example, where the display 147 may be physically located within the physical environment 102. In some implementations, the augmented reality integration engine 128a at the servers 108 may operate in conjunction with the augmented reality integration engine 128b at the local computing device 110.

The virtual product adjustment engine 130a may execute or operate to obtain an indication of an adjustment to the AR representation (where the indication of the adjustment may be obtained via the user interface 138b), and modify or otherwise adjust the AR representation in accordance with the obtained indication of the adjustment to generate an adjusted AR representation. In some implementations, the virtual product adjustment engine 130a at the servers 108 may operate in conjunction with the virtual product adjustment engine 130b the local computing device 110. Adjustments may include, for example, adjustments to the wearable item 140 (e.g., different size, color, hem length, sleeve length, etc.); adjustments to the virtual depiction of the wearable item (e.g., adjust locations of waypoints of various features of the garments, add more detail to the virtual depiction, etc.); adjustments to the appearance of the user 112 (e.g., zoom in to view details of a portion of the user's face or body, change a characteristic of the user 112 such as hair color or hair style, an addition or deletion of another wearable item depicted in combination with the initial wearable item; and the like. The adjusted AR representation may be presented on the image of the user 112 which is being presented on the display 147, 138b, for example. The one or more ML models 132 may be executed or operate to, for example, generate a virtual depiction of the wearable item 140, generate a virtual mapping or 3D mesh of at least a portion of the appearance of the user 112, generate an indication of one or more wearable items and/or adjustments thereto which are in accordance with historical preferences and/or behaviors of the user (which may be stored, for example, as a user data set in the user information data store 150), and/or other operations related to providing individualized or personalized virtual try on of wearable items. The ML model training engine 135 may execute or operate to train the one or more ML models 132 and to re-train the one or more ML models 132 as additional historical data related to the user 112, the wearable item 140, and/or to the virtual trying on of the wearable item 140 by the user 112 are obtained.

In some embodiments, the one or more sensors 152a included in the back-end environment 105 may include one or more sensing devices, hardware sensors, and/or software sensors operable to detect conditions associated with individualized personalization of virtual try on of wearable items, e.g., as described in embodiments herein. For example, the image capturing device(s) 145 and/or the sensors 152b disposed in the front-end environment 102 may include one or more image sensors and/or other types of sensors (e.g., scanners, short-range wireless sensors, etc.) which are configured to detect the physical presences of various wearable items (for example, optically and/or via other radio frequency (RF) mechanisms such as infrared, Bluetooth, RFID, Zigbee, etc. e.g., in conjunction with tags and/or sensors attached to or included in the wearable item), and the sensors 152a disposed in the back-end environment 105 may include one or more image processing sensors configured to process data obtained by the front-end image capturing device(s) 145 and/or the sensors 152b. Additionally or alternatively, the one or more sensors 152a included in the back-end environment 105 may include one or more software-based sensors, such as a calendar sensor to detect a time/day date, an IP or other type of virtual address sensor to detect a physical or virtual location, and the like. In some embodiments, the sensors 152a may include the user interface 138a, as the user interface 138a may be configured to detect conditions received via the user interface 138a (e.g., the reception of logins, instructions or commands, etc.). Of course, the one or more sensors 152a may additionally or alternately include other types of sensors, if desired.

Turning now to the local computing device 110 of the system 100, the local computing device 110 may be disposed within the physical enterprise environment 102, and may include one or more processors 120b and one or more tangible, non-transitory memories 125b. The one or more processors 120b may include any suitable number of processors and/or processor types (e.g., one or more central processing units (CPUs)). Processor 120b may include one or more CPUs and one or more graphics processing units (GPUs), for example. Generally, processor 120b is configured to execute software and/or other types of computer-executable instructions stored in the one or more memories 125b. The one or more memories 125a may be implemented by any suitable one or more persistent memories, such as Random Access Memories (RAMs), Read-Only Memories (ROMs), flash memory, hard drives, solid state memories, and/or other types of persistent memories.

The local computing device 110 may be and/or may include, for example, a smartphone, a smart mirror, a kiosk or customer service device at a retailer, a smart device, a tablet, a laptop, a phablet, a wearable computing device, another type of personal computing device, a smart glass device, a smart watch device, an augmented reality device, a virtual reality device, etc. For example, the local computing device 110 may include a personal computing device (e.g., a laptop, desktop, tablet, PED, etc.) operated by the user 112, such as a person who would like to view a customized or personalized virtual try-on of one or more wearable items (e.g., of themselves or of another party), or an agent of the retailer or enterprise. Additionally or alternatively, the local computing device 110 may include a computing device that is fixedly or movably disposed at a location at which the user 112 has physically arrived (e.g., in a physical retail location, a dressing room, etc.). Indeed, in some implementations, the local computing device 110 may include multiple local computing devices. For ease of reading herein and not for limitation purposes, though, the local computing device 110, the one or more processors 120b, and the one or more memories 125b may be referred to herein using the singular tense.

As shown depicted in FIG. 1, the memories 125b of the local computing device 110 may store one or more sets of computer-executable instructions, such as an augmented reality user interface engine 142. Generally, the AR user interface engine 142 may include instructions for detecting user input in accordance with the embodiments described herein. In some embodiments, the AR user interface engine 142 may include instructions for detecting user input via a touch screen display (e.g., included in the local user interface 138b), via voice commands from the user (e.g., by utilizing the local user interface 138b), via physical gestures (e.g., detected by the image capturing device 106 and/or the sensors 152b), and/or via another suitable user interface configuration. The AR user interface engine 142 may also include instructions (e.g., to a user) for presenting AR representations of a virtual depiction of a wearable item 140 on the user 112 in accordance with the embodiments disclosed herein.

To implement any one or the techniques disclosed herein, in embodiments the memories 125b of the local computing device 110 may optionally store an augmented reality integration engine 128b and/or a virtual product adjustment engine 130b, which may be respective instances of the augmented reality integration engine 128a and the virtual product adjustment engine 130a stored at the server 108, or which may differ from but operate in conjunction with (e.g., cooperatively operate with) the augmented reality integration engine 128a and the virtual product adjustment engine 130a stored at the server 108. For example, the augmented reality integration engine 128a at the server 108 and the augmented reality integration engine 128b at the local computing device may cooperatively operate using a client-server paradigm or architecture, a web service call, etc. to implement one or more of the techniques disclosed herein. In some implementations, the one or more memories 125b may store additional sets of other computer-executable instructions 136b. Generally speaking, each of the augmented reality user interface engine 142, the augmented reality integration engine 128b, the virtual product adjustment engine 130b, and the other instructions 136b may include respective computer-executable instructions which, when executed by the one or more processors 120b, may cause the local computing device 110 (and in some cases the system 100) to implement one or more of the techniques described elsewhere herein.

Additionally, the local computing device 110 may include one or more user interfaces 138b. The one or more user interfaces 138b may include one or more suitable types of user input devices, such as integrated and/or external keyboards, touch screen displays, a mouse or touch pad, microphones, and/or any suitable types of remote and/or local user input devices, along with associated software and/or firmware. The one or more user interfaces 138b and may include one or suitable types of output devices, such as displays (which may be touch screen displays), speakers, and the like, along with associated software and hardware. For ease of reading (and not limitation) purposes, user interface(s) 138b may be referred to herein using the singular tense.

As shown in FIG. 1, the local computing device 110 and/or the server 108 may be communicatively coupled to one or more image capturing devices 145 which typically may be disposed at the physical location 102 of the enterprise and proximate to the local computing device 110. The one or more image capturing devices 145 may include, for example, a camera, a web cam, a smart mirror, an augmented reality device, an optical scanner, etc. In some implementations, at least one of the image capturing devices 145 may be fixedly disposed in the location at which the user 112 is physically located (e.g., a web cam, an optical scanner, a smart mirror, etc. which is fixedly disposed at the enterprise location 102). Additionally or alternatively, at least one of the image capturing devices 145 may be integrated into the local computing device 110. In some implementations, one or more the image capturing devices 145 may include multiple devices. For example, image capturing device(s) 145 may include multiple two-dimensional cameras whose outputs are combined to generate a three-dimensional image, and/or image capturing devices 145 may include an optical scanner disposed in a dressing room and configured to scan digital codes, as well as a camera included in a PED of the user 112 configured to capture digital images of its field-of-view. Generally, the image capturing device(s) 145 may be configured to capture static images, dynamic images (such as videos), two-dimensional images, and/or three-dimensional images, e.g., of wearable items 140, of the user 112, of digital codes, etc. For ease of reading (and not limitation) purposes, the one or more image capturing devices 145 may be referred to herein using the singular tense.

The one or more sensors 152b of the local computing device 110 may include one or more sensing devices, hardware sensors, and/or software sensors. For example, the one or more sensors 152b may include one or more wireless sensors, optical sensors, touch sensors, and/or other types of sensors configured and operable to detect conditions within the front-end environment 102. Such detected conditions may include, for example, the respective presences of one or more other devices (e.g., image capturing device 145, display 147, a PED or device operated by the user 112), the presence of the user 112, and/or the presence of the wearable item 140 within the front-end environment 102. For example, the one or more sensors 152b may include one or more optical sensors configured to optically detect or otherwise capture image data indicative of objects that are perceived or sensed within the sensors'respective fields-of-view, such as people, wearable items, quick response (QR) codes, barcodes, other types of digital codes, etc. Additionally or alternatively, the one or more sensors 152b may be configured to wirelessly detect objects within the range of the sensors'wireless transceivers, such as a PED operated by the user 112 and/or a near field communication (NFC) tag and/or another type of tag or device which utilizes some other suitable short range communication protocol, such as a tag and/or sensors attached to and/or included in the wearable item 140. It is noted that in some embodiments, the sensors 152b may be configured to perform some or all of the functions of the sensors 152a, either alone or in combination with the sensors 152a, and vice versa, the sensors 152a may be configured to perform the functions of the sensors 152b, either alone or in combination with the sensors 152b. Further, it is noted that although FIG. 1 depicts the sensors 152a as being included in the local computing device 110, in some embodiments (not depicted in FIG. 1), at least some of the sensors 152a may be disposed separately (e.g., excluded) from the local computing device 110 within the front-end environment 102. For example, at least one of the sensors 152a may be included in the image capturing device 145 and/or at least one of the sensors 152a may be fixedly or otherwise permanently located within the front-end environment 102.

The system 100 may further include a virtual depiction data store 148 and a user information data store 150, each of which may be accessed by the server 108 and/or by the local computing device 110 to execute or perform one or more of the disclosed techniques, e.g., as is described in more detail elsewhere herein. Generally, the virtual depiction data store 148 may store a respective virtual depiction of each wearable item of a plurality of wearable items offered by the enterprise. Each virtual depiction may include respective rendering data so that the virtual depiction of the corresponding wearable item may be rendered or depicted on a display. As such, each virtual depiction may be associated with an identifier of the corresponding wearable item, e.g. a stock keeping unit (SKU) code, a universal product code (UPC), or other suitable identifier that uniquely identifies (within the virtual depiction data store 148) the wearable item, e.g., that identifies not only the product name or identity of the wearable item, but also other characteristics of the wearable item such as color, cut, length, finish, etc. Additionally, in some embodiments, each virtual depiction may include a plurality of depiction waypoints of the wearable item, where each depiction waypoint may be labeled or otherwise identified or distinguished from other depiction waypoints of the wearable item. For example, a set of depiction waypoints for a dress shirt may include respective waypoints for the left collar point of the dress shirt, right collar point, first button, second button, side seam start, side seam end, etc. Further, the virtual depiction may include data indicative of spatial location relativity of each of the plurality of depiction waypoints with respect to others of the plurality of depiction waypoints for the wearable item. At least some of the virtual depictions stored in the data store 148 may be pre-defined and/or obtained from other systems and/or applications. In some situations, at least some of the virtual depictions of wearable items may be generated in-line with the detection of the physical presence of the wearable item by the system 100, e.g., by utilizing the image capturing device 140, one or more of the machine learning models 132, etc. and stored into the data store 148. For example, if a detected wearable item does not have an associated virtual depiction stored in the virtual depiction data store 148, the system 100 may automatically generate a corresponding virtual depiction of the detected wearable item (e.g., via image capturing device 140, one or more of the ML models 132, etc.), determine respective waypoints within the virtual depiction, and store the generated virtual depiction of the detected wearable item and corresponding waypoints into the virtual depiction data store 148. In some situations, the system 100 may request the user 112, e.g., via user interface 138b, to rotate the orientation and/or otherwise adjust the placement of the detected wearable item with respect to the view finder of the image capturing device 145 so that the system 100 may generate the necessary waypoints of the detected wearable item. The generated virtual depiction of the detected wearable item (including waypoints) along with other information associated with the detected wearable item such as identification, size, color, length, and/or other characteristics may be stored into the virtual depiction data store 148.

The user information data store 150 may store respective information for each user of a plurality of users associated with the system 100, where the respective information for a user is categorically referred to herein as a “profile” of the user or a “user profile. ” A profile of a user (e.g., the user 112) may include, for example, an identifier of the user, indications of preferences of the user, one or more images of the user, one or more virtual mappings and/or 3D meshes of the appearance of various portions and/or the entirety of the user (e.g., the user's face, neck, torso, entire body, etc.), and/or other information corresponding to the user. Accordingly, the user information data store 150 is interchangeably referred to herein as the ‘virtual mappings data store 150,” as the data store 150 may include at least virtual mappings or 3D meshes of various users. In some embodiments, at least some of the 3D meshes of a user may be pre-defined and/or obtained from other systems and/or applications and stored in association with the user profile. In some embodiments, at least some of the 3D meshes of the user may be generated by the system 100 in-line with the detection of the physical presence of the wearable item 140 and/or the physical presence of the user 112. For example, the system 100 may obtain an image of the user 112 (e.g., in real-time via image capturing device 145 or from an image stored in conjunction with the user's profile) and generate a corresponding 3D-mesh of the user 112 in-line with performing a virtual try on of one or more wearable items on the user, e.g., by utilizing one or more of the machine learning models 132. In an embodiment, at least some of the virtual mappings or 3D meshes of the user may be generated by utilizing one or more mesh generation techniques as described in U.S. patent application Ser. No. 18/748,856 entitled “Accurate Cosmetic Application Through Advanced Facial Mapping” and filed on Jun. 20, 2024, the disclosure of which is incorporated herein by reference in its entirety. For example, to generate a 3D mesh of an appearance of the user, the system 100 may process the image of the user 112 obtained by the image capturing device 145 (or stored in the user information data store 150) and iteratively evaluate points or landmarks of the depicted face and/or body of the user to eventually positively identify the points/landmarks with the image, e.g., by utilizing one or more ML models 132 and/or artificial intelligence (AI) and/or computer vision techniques, such as, but not limited to, deep learning, artificial neural networks (fuzzy neural networks, feedforward neural networks, convolutional neural networks, etc.), hidden Markov models, classification, clustering, principal component analysis (PCA), discrete cosine transform (DCT), linear discriminant analysis (LDA), locality preserving projection (LPP), Gabor wavelet techniques, independent component analysis (ICA), generative adversarial networks (GANs), federated learning, and/or other approaches for user waypoint identification/recognition/generation. It should be appreciated that generating the 3D mesh of the user may comprise various new or existing techniques, particularly including new or existing AI techniques (e.g., new or existing machine learning techniques). These new or existing techniques may include open source techniques, proprietary techniques, and/or other techniques, including combinations thereof. At any rate, based on the identified waypoints, the system 100 may (e.g., via the one or more ML models 132 and/or other AI and/or computer vision techniques) identify features of the user's face and/or body and spatial relationships between different user features. Further, the system 100 may repeatedly and/or continuously regenerate and/or adjust the 3D mesh of the user 112 based upon new image data obtained via the image capturing device 145 and/or other sources.

Additionally, in embodiments, the profile of the user 112 stored in the user information data store 150 may store historical data pertaining to the user 112 in relation to the enterprise. User historical data may include data indicative of wearable items which the user 112 has previously tried-on and respective characteristics of the wearable items, either virtually and/or physically; combinations of wearable items which the user 112 has previously tried-on, either virtually and/or physically; virtual depictions of previously tried-on wearable items, which may include respective waypoints and respective characteristics thereof; mappings of the virtual depictions or wearable items to one or more images of the user 112; wearable items which have been purchased, returned, or exchanged by the user 112; combinations of wearable items which have been purchased, returned, or exchanged by the user 112 (e.g., in a single transaction or over several transactions); interactions of the user 112 with the enterprise or retailer related to the wearable items (e.g., via various contact and communication channels of the enterprise, which may include virtual or electronic storefronts); physical locations and/or virtual locations at which the user 112 performed actions related to the try-ons and purchase of wearable items; time/date stamps of historical actions; historical behaviors of the user 112 with respect to the enterprise; preferences of the user 112 related to the try-on of wearable items; data indicative of the characteristics of the aforementioned historical wearable items; similar historical data related to the user and other associated enterprises; and/or other types of historical data related to the user 112 and to the enterprise.

In addition, memories 125a and/or 125b may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein, and/or associated actions, methods, and techniques. For instance, in some examples, the computer-readable instructions stored on the memories 125a and 125b may include instructions for carrying out any of the steps of the methods described herein via an algorithm executing on the processors 120a and/or 120b. It should be appreciated that one or more other applications may be envisioned and executed by the processor(s) 120a and/or 120b.

### Example Method

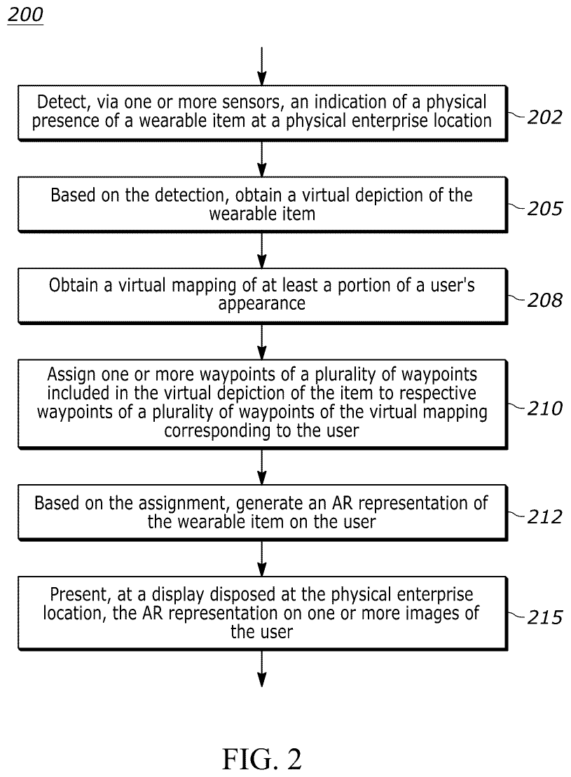

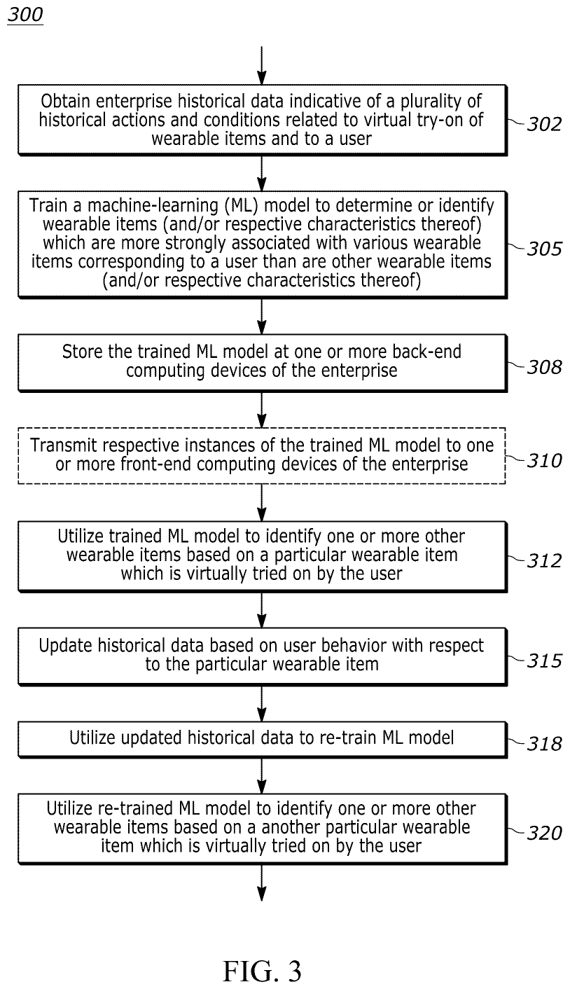

FIG. 2 depicts a flow diagram of an exemplary computer-implemented method 200 at an augmented reality (AR) system for customizing or personalizing virtual try on of wearable items, e.g., at a physical location of or associated with an enterprise which provides the wearable item. In an embodiment, at least a portion of the method 200 is performed by a system configured to provide customized or personalized virtual-try on of a wearable item (e.g., at a physical location of an enterprise which provides the wearable item), such as the AR system 100. For example, the augmented reality integration engine 128a, the virtual product adjustment engine 130a, and/or the ML model(s) 132 stored on the memories 125a of the system 100 may be executed by processors 108 to cause the system 100 to execute at least a portion of the method 200. Additionally or alternatively, the augmented reality user interface engine 142, the augmented reality integration engine 128b, and/or the virtual product adjustment engine 130b stored on the memories 125b of the local computing device(s) 110 may be executed by the processors 120b to cause the system 100 to execute at least a portion of the method 200. Generally speaking, one or more portions of the method 200 may be executed or performed by one or more processors 120b disposed in the physical enterprise location (e.g., a front environment 102 of the AR system 100) and/or may include one or more processors 120a disposed at one or more servers (e.g., a back-end environment 105 of the AR system 100). For ease of discussion herein (and not for limitation purposes), the method 200 is described with simultaneous reference to FIG. 1, although it is understood that any one or more portions of the method 200 may be utilized in systems other than the example system 100. Further, in some embodiments, at least a portion of the method 200 may operate in conjunction with at least a portion of the method 300 of FIG. 3. Still further, in some embodiments the method 200 may include additional or alternate blocks other than those depicted in FIG. 2.

At a block 202, the method 200 may include detecting, via one or more sensors disposed at a physical location of or associated with an enterprise and by one or more processors of the AR system, an indication of a physical presence of a wearable item, e.g., at the physical enterprise location. As previously discussed, the physical enterprise location is a physical location at which physical wearable items associated with the enterprise (e.g., clothing, jewelry, accessories, etc.) are physically located. Accordingly, the one or more sensors may include at least the sensors 152b and/or the image capturing device 145 disposed within the physical enterprise location 102. As such, the detecting sensors may include one or more scanners, touch sensors, short-range wireless sensors, optical sensors, image processors, and/or other types of RF-range sensors such as infrared, Bluetooth, RFID, Zigbee, and the like. The sensors may detect the proximate physical presence of the wearable item itself and/or the sensors may detect the proximate physical presence of a transmitter or a code which is included in the materials of which the wearable item is made, and/or in or on a tag or device attached to the wearable item, such as an RFID tag or a QR code. In some implementations, the transmitter or the code may also provide additional information about the wearable items and/or its characteristics, such as SKU code, UPC, size, color, style, and/or the like. At least some of the sensors may be fixedly attached and/or disposed at the physical enterprise location, and/or at least some of the sensors may be included in a PED being operated by a user who is physically located within the physical enterprise location, for example.

At a block 205, the method 200 may include, responsive to the detecting 202, obtaining, by the one or more processors, a virtual depiction of the wearable item. The obtaining 205 of the virtual depiction of the detected wearable item may be performed by, for example, obtaining the virtual depiction of the wearable item from a data store storing respective virtual depictions of a plurality of wearable items in which the wearable item is included, such as the data store 148. Additionally or alternatively, the obtaining 205 of the virtual depiction of the detected wearable item may be obtained by generating, in-line with the execution of the method 200, at least a part of the virtual depiction of the detected wearable item via data obtained by one or more sensors 152b, 145 disposed in the physical environment 102. For example, the data obtained by the one or more sensors 152b, 145 may be provided to one or more machine learning models 132 and/or to one or more image processing modules (which may be included in the other instructions 136a and/or 136b) to generate at least a portion of the virtual depiction of the detected wearable item. The obtained virtual depiction of the wearable item may include a plurality of depiction waypoints of the wearable item along with data indicative of relative spatial locations (e.g., relative three-dimensional spatial locations) between various depiction waypoints, which may have been pre-labeled and/or pre-defined, and/or which may have been detected and/or generated in-line with the execution of the method 200, e.g., by the one or more machine learning models 132 and/or the one or more image processing modules 136a, 136b.

At a block 208, the method 200 may include obtaining, by the one or more processors, a virtual mapping of at least a portion of an appearance of a user or person for which the customized or personalized virtual try on of the detected wearable item is to be generated, e.g., the “subject” or “subject person” of the customized or personalized virtual try-on. In some embodiments, at least a portion of the virtual mapping of the subject may be obtained 208 from a data store storing a plurality of virtual mappings of a plurality of subjects in which the subject is included, such as the data store 150. Additionally or alternatively, at least a portion of the virtual mapping of the subject may be generated, in-line with the execution of the method 200, via appearance data of the subject obtained by the one or more sensors 152b, 145 disposed in the physical environment 102. For example, the data obtained by the one or more sensors 152b, 145 may be provided to one or more machine learning models 132 and/or to one or more image processing modules (which may be included in the other instructions 136a and/or 136b) to generate at least a portion of the virtual appearance of the subject and detect, generate, and identify a plurality of waypoints of the appearance of the subject along with data indicative of relative spatial locations (e.g., of relative 3D spatial locations) between various depiction waypoints. The obtained virtual mapping of the at least a portion of the appearance of the user may include a plurality of waypoints of the user's appearance along with data indicative of relative spatial locations (e.g., relative three-dimensional spatial locations) between various waypoints of the user's appearance, which may have been pre-labeled and/or pre-defined, and/or which may have been detected and/or generated in-line with the execution of the method 200, e.g., by the one or more machine learning models 132 and/or the one or more image processing modules 136a, 136b.

At a block 210, the method 200 may include assigning, by the one or more processors, one or more waypoints of a plurality of waypoints of the virtual depiction of the wearable item to respective waypoints of a plurality of waypoints of the virtual mapping corresponding to the subject person. For example, one or more waypoints of the neck opening of a virtual depiction of a shirt may be assigned to various waypoints of the neck of the virtual mapping of the subject person, and based on the relative positions of the neck opening with respect to the shoulder seams of the shirt in the virtual depiction of the shirt, the waypoints of the shoulder seams of the shirt may be assigned, in a relative manner, to correspond to the waypoints of the shoulders of the virtual mapping of the subject person and/or to other waypoints of the virtual mapping of the subject person (e.g., arms, chest, back, etc.) based on relative spatial positions (e.g., relative three-dimensional or 3D spatial positions) of the waypoints of the neck of the subject person with respect to the waypoints of the shoulders of the subject person as indicated in the virtual mapping of the subject person. In another example, waypoints of a nose bridge, frame shape, and earpieces of a virtual depiction of a pair of sunglasses may be assigned to various waypoints of the face and head of the virtual mapping of a user's face, e.g., in a relative manner based on the relative spatial locations (e.g., relative 3D spatial locations) of the waypoints of the virtual depiction of the sunglasses with respect to each other, and based on relative spatial locations of the waypoints of the virtual mapping of the subject person's face and head with respect to each other.

At a block 212, the method 200 may include generating, based on the assigning 210 of the waypoints of the virtual depiction of the item to the respective waypoints of the virtual mapping of the subject person, an AR representation of the wearable item on the subject person, and at a block 215, the method 200 may include presenting, at a display disposed at the physical enterprise location and by the one or more processors, the AR representation on one or more images of the subject. For example, the AR representation may be applied to or overlaid on an image or depiction of the subject, e.g., by aligning the virtual mapping of the subject corresponding to the AR representation and the image or depiction of the subject. The image or depiction of the subject may be a static or dynamic image of the subject, and the image or depiction of the subject may be a two-dimensional or three-dimensional image of the subject. When the image of the subject is a dynamic image of the subject (e.g., a live stream feed of the subject or a stored video of the subject), the presentation 215 of the AR representation on the dynamic image of the subject person may be a dynamic presentation which dynamically changes in accordance with the dynamic changes of the image of the subject person, to thereby indicate how the wearable item would appear on the subject person from different angles and/or as the subject person moves. The AR representation of the wearable item on the subject person may be presented, for example, at one or more of the user interface 138a, 138b, or another user interface.

In some implementations, the blocks 202-212 may be executed by the augmented reality integration engine 128a and/or by the augmented reality integration engine 128b. In some implementations, the block 215 may be executed by the augmented reality integration engine 128a, the augmented reality integration engine 128b, and/or the augmented reality user interface engine 142. The augmented reality user interface engine 142 may operate in conjunction with the user interfaces 138a and/or the user interfaces 138b, for example.

In some embodiments of the method 200 (not shown), the method 200 may further include receiving, via a user interface such as the user interface 138a or 138b, and/or via the augmented reality user interface engine 142, an indication of one or more adjustments to the AR representation of the wearable item on the image of the subject person. The one or more adjustments may include adjustments to the wearable item, for example, a change to a color of the wearable item, to a size of the wearable item, to a material of the wearable item, and/or to another characteristic of the wearable item. Additionally or alternatively, the one or more adjustments may include a change to the virtual depiction of the wearable item, such as the resolution or amount of detail included in the virtual depiction and/or the granularity of the virtual depiction. For example, the user may take a close-up photo of the wearable item in real-time and provide the close-up photo to the system 100, and the system 100 may adjust the virtual depiction of the wearable item based on data included in the close-up photo. Still additionally or alternatively, the one or more adjustments may include a change to a characteristic of the appearance of the subject person. For example, the one or more adjustments to the appearance of the subject person may include a different hair or eye color, a different make-up look, a different hair style, etc. At any rate, based on the receiving of the one or more adjustments, the method 200 may include generating an adjusted AR representation of the wearable item on the image of the subject person, and presenting, at one or more user interfaces, the adjusted AR representation of the wearable item on the one or more images of the subject person. For example, in some implementations, the adjusting of the AR representation of the wearable item of the image of the subject person may be performed, for example, by the virtual product adjustment engines 130a, 130b, either alone or in combination.

In some embodiments (not shown), the method 200 may further include presenting multiple AR representations of multiple wearable items on an image of the subject person, e.g., in a simultaneous manner. For example, the wearable item which was detected (block 202) may be a first wearable item, and the method 200 may additionally include receiving second input data indicative of a second wearable item. The second input data indicative of the second wearable item may be provided by one or more sensors which have detected the physical presence of the second wearable item (e.g., in a manner similar to that described with the block 202), in an embodiment. In an embodiment, the second input data indicative of the second wearable item may be a selection of the second wearable time from among a plurality of other wearable items or another type of indication of the second wearable item, where the selection or indication of the second wearable item is provided by a user via the user interface 138a, the user interface 138b, and/or the augmented reality user interface engine 142. In some scenarios, the second input data indicative of the second wearable item may be an automatic selection of the second wearable item by one or more of the augmented reality integration engines 128a, 128b, e.g., in cooperation with one or more of the machine learning models 132. For example, based on the identity of the first wearable item and/or the AR representation of the first wearable item on the image(s) of the subject person, the one or more ML models 132 may execute to determine or suggest a second wearable item based on preferences and/or based on previous behaviors and/or interactions of the subject person with the system 100 (e.g., as indicated by information or data sets stored in a respective user profile 150 of the subject person). At any rate, upon obtaining the second input data indicative of the second wearable item, the method 200 may obtain, based on the second input data, a second virtual depiction of the second wearable item; generate, based on a plurality of waypoints included in the second virtual depiction of the second wearable item and the plurality of waypoints included in the virtual mapping corresponding to the subject person, a second AR representation of the second wearable item on the subject person; and present, at the display or on another display, the second AR representation on the one or more images of the subject person, such as in manners similar to those discussed above.

### Machine-Learning Models

As previously discussed, in embodiments, the system 100 may include one or more machine-learning (ML) models 132 which have been trained (e.g., via the machine-learning model training applications 135, and by using supervised and/or unsupervised machine learning techniques) on historical data associated with the enterprise to perform various tasks and/or functions associated with customized or personalized virtual try-on of wearable items. For example, the one or more ML models 132 may be utilized to perform at least a portion of the method 200 of FIG. 2.

In embodiments, the one or more machine learning (ML) models 132 may include an ML model trained to generate a virtual mapping or 3D mesh of an appearance of a user or subject person 112. For example, the system 100 may process an image of the user 112 which is obtained by the image capturing device 145 in real-time or in-line with an execution of the method 200, or which has been previously obtained and stored in the user information data store 150. For instance, the system 100 may, by utilizing one or more ML models 132 and/or artificial intelligence (AI) and/or computer vision techniques, iteratively evaluate points or landmarks of the depicted face and/or body of the user 112 within the image to eventually positively identify the points/landmarks of the depicted face and/or body of the user 112. Such ML models 132 and/or artificial intelligence (AI) and/or computer vision techniques may include one or more techniques such as, but not limited to, deep learning, artificial neural networks (fuzzy neural networks, feedforward neural networks, convolutional neural networks, etc.), hidden Markov models, classification, clustering, principal component analysis (PCA), discrete cosine transform (DCT), linear discriminant analysis (LDA), locality preserving projection (LPP), Gabor wavelet techniques, independent component analysis (ICA), generative adversarial networks (GANs), federated learning, and/or other approaches for user waypoint identification/recognition/generation. It should be appreciated that generating the virtual mapping or 3D mesh of the user 112 and respective waypoints may comprise various new or existing techniques, such as new or existing AI, computer vision, and/or machine learning techniques. These new or existing techniques may include, for example, open source techniques, proprietary techniques, and/or other techniques, including combinations thereof. At any rate, based on the identified waypoints, the system 100 may (e.g., via the one or more ML models 132 and/or other AI, computer vision, and/or ML techniques) identify features of the user's face and/or body and spatial relationships (e.g., three dimensional spatial relationships) between different user features, and may assign and/or identify one or more respective waypoints to each user feature. The generated virtual mapping or 3D mesh of the user's face and/or body and its respective waypoints may be stored in the user information data store 150. Further, the system 100, via the ML models 132, may repeatedly and/or continuously regenerate and/or adjust the virtual mapping or 3D mesh of the user or subject 112 based upon new or additional image data obtained via the image capturing device 145, the one or more sensors 152a, 152b, and/or other sources.

In embodiments, and in a similar manner, the one or more ML models 132 may include an ML model trained to generate a virtual depiction of a wearable item and its corresponding waypoints. For example, the system 100 may process an image of the physical wearable item 140 disposed at the physical location 102 of the enterprise, where the image of the wearable item 140 has been previously stored in the virtual depiction data store 148, or where the image of the wearable item 140 is captured and generated in real time (e.g., in-line with the execution of the method 200) based on data generated by the image capturing device 145 and/or other optical sensors 152b disposed at the physical location 102. The system 100 may, by utilizing one or more ML models 132 and/or artificial intelligence (AI), ML, and/or computer vision techniques, iteratively evaluate points or landmarks of the image of the wearable item 140 to eventually positively identify the points/landmarks of the wearable item 140 within the image, The one or more ML models 132 and/or artificial intelligence (AI), ML, and/or computer vision techniques may include one or more techniques such as, but not limited to, deep learning, artificial neural networks (fuzzy neural networks, feedforward neural networks, convolutional neural networks, etc.), hidden Markov models, classification, clustering, principal component analysis (PCA), discrete cosine transform (DCT), linear discriminant analysis (LDA), locality preserving projection (LPP), Gabor wavelet techniques, independent component analysis (ICA), generative adversarial networks (GANs), federated learning, and/or other approaches for waypoint identification/recognition/generation. It should be appreciated that generating the virtual depiction of the wearable item 140 and its respective waypoints may comprise various new or existing AI, computer vision, and/or machine learning techniques. These new or existing AI, computer vision, and/or machine learning techniques may include open source techniques, proprietary techniques, and/or other techniques, including combinations thereof. At any rate, based on the identified waypoints, the system 100 may (e.g., via the one or more ML models 132 and/or other AI and/or computer vision techniques) identify features of the wearable item (e.g., seams, pieces, lengths, widths, etc.) and spatial relationships (e.g., three dimensional spatial relationships) between different features of the wearable item 140, and may assign and/or identify one or more respective waypoints to each item feature. The generated virtual depiction of the wearable item 140 and its respective waypoints may be stored in the virtual depiction data store 148. Further, the system 100, via the ML models 132, may repeatedly and/or continuously regenerate and/or adjust the virtual depiction of the wearable item 140 based upon new or additional image data obtained via the image capturing device 145, the one or more sensors 152a, 152b, and/or other sources.

Additionally or alternatively, the one or more ML models 132 may include an ML model trained to generate indications (e.g., suggestions, recommendations, options, etc.) of one or more other recommended wearable items which correspond to the physical wearable item 140 and to the user or subject 112. For example, the ML model may generate an indication of another, categorically similar (e.g., pants, shirt, sweater, hat, belt, earrings, etc.) wearable item which has one or more different characteristics than the physical wearable item 140 (e.g., a different size, cut, color, length, model, material, etc.) which may better fit or suit the user 112, e.g., based on the waypoints of the virtual mapping of the appearance of the user 112 and optionally based on preferences of the user 112, for instance, as indicated in the user's profile 150. Additionally or alternatively, the ML model may generate an indication of another wearable item altogether which is recommended as an alternative or an addition to the physical wearable item 140, e.g., based on the waypoints of the virtual mapping of the appearance of the user 112 and optionally based on preferences of the user 112, for instance, as indicated in the user's profile 150. Generally speaking, the indications of the one or more other wearable items may be customized for the user or subject person 112, and in some cases may be unique to the user or subject person 112. To this end, such ML models may be trained based on historical data stored in the profile 150 of the user or subject 112, where such data may indicate historical behaviors, characteristics, and preferences of the user or subject 112; virtual mappings of the user's face and/or body; previous AR representations of other wearable items; previous AR representations of the other wearable items applied to images of the user or subject 112 (e.g., which the user 112 has previously tried-on virtually); previous purchases, returns, and exchanges of the user 112; and respective characteristics of the wearable items, to name a few. In some situations, such ML models may trained based on both the user profile 150 and data stored in the virtual depictions data store 148 (e.g., data indicative of respective virtual depictions, waypoints, and features of wearable items). The ML models may be trained on such user-specific historical data to determine or identify wearable items (and/or respective characteristics thereof) which are more strongly associated with one or more characteristics of the wearable item 140 and with the user or subject 112 than are other wearable items (and/or respective characteristics thereof), and/or to determine combinations of wearable items which are associated with the wearable item 140 and the user 112 and are more likely to be purchased by the user 112 than other combinations of wearable items. Further, in some embodiments, the system 100 may generate a new AR representation of the indicated wearable item(s), e.g., by using techniques such as discussed elsewhere herein, and may present the new AR representation on the one or more images of the user 112, either in conjunction with the previous AR representation, or as a substitute for the previous AR representation.

FIG. 3 depicts a flow diagram of an exemplary computer-implemented method 300 at an augmented reality (AR) system training and re-training a machine-learning (ML) model for customizing or personalizing the virtual try on of wearable items, e.g., at a physical location of or associated with an enterprise which provides the wearable item. In an embodiment, at least a portion of the method 300 is performed by a system configured to provide customized or personalized virtual-try on of a wearable item (e.g., at a physical location of an enterprise which provides the wearable item), such as the AR system 100. For example, one or more of the machine learning model training applications 135 stored on the memories 125a of the system 100 may be executed by processors 108 to cause the system 100 to execute at least a portion of the method 300. Generally speaking, one or more portions of the method 300 may be executed or performed by one or more processors 120a disposed at one or more servers or back-end computing devices (e.g., computing devices disposed in a back-end environment 105 of the AR system 100). For ease of discussion herein (and not for limitation purposes), the method 300 is described with simultaneous reference to FIG. 1, although it is understood that any one or more portions of the method 300 may be utilized in systems other than the example system 100. Further, in some embodiments, at least a portion of the method 300 may operate in conjunction with at least a portion of the method 200 of FIG. 2. Still further, in some embodiments the method 300 may include additional or alternate blocks other than those depicted in FIG. 3

At a block 302, the method 300 may include obtaining historical data indicative of a plurality of historical actions related to the virtual try-on of wearable items and a user. The historical data indicative of the plurality of historical actions related to the virtual try-on of wearable items and the user 112 may be stored in a profile of the user 112 included in the user information data store 150 and obtained therefrom, for example.

At a block 305, the method 300 may include training a machine learning (ML) model to determine or identify one or more wearable items (and/or respective characteristics thereof) which are more strongly associated with wearable items which historically correspond to the user (e.g., various wearable items which have been previously tried-on and/or purchased by the user) than are other wearable items (and/or respective characteristics thereof). For example, one or more of the ML models 132 may be trained based on the obtained historical data (block 302) to determine, given each of the previous wearable items which the user 112 has virtually and/or physically tried on and/or purchased (and/or its respective characteristics), one or more wearable items (and/or their respective characteristics) which are more strongly associated with the each previous wearable item corresponding to the user than are other wearable items (and/or their respective characteristics). For instance, the ML model may be trained based on historical data which includes images of the user, virtual mappings or 3D meshes of appearances of the user, waypoints of such virtual mappings/3D meshes corresponding to the user, images of wearable items which the user has previously virtually and/or physically tried-on and/or purchased, virtual depictions of such wearable items historically associated with the user, waypoints of such virtual depictions of wearable items historically associated with the user, features and/or characteristics of such wearable items historically associated with the user, data indicative of previous user behaviors (e.g., virtual and/or physical try-ons; substitutions of and/or additions to wearable items which have been virtually or physically tried-on; purchases, exchanges, returns of wearable items, either alone or in combination, etc.) and/or user preferences, to name a few. Training 305 the ML model may utilize supervised and/or unsupervised training techniques, as suitable and as desired.

At a block 308, the method 300 may include storing the trained ML model at one or more back-end computing devices of the enterprise. For example, the trained machine learning model 132 may be stored within the back-end memories 125a of the system 100, and the instructions 128a, 130a, 132, and 136a may utilize the stored ML model 132 to perform any one or more of the techniques described herein.

At an optional block 310, the method 300 may include transmitting respective instances of the trained ML model 132 to one or more front-end computing devices 110 of the enterprise. The front-end computing device 110 may store the received instance of the trained ML model 132, for example, in its memories 125b, and the instructions 128b, 130b, 136b, 142 may utilize the stored instance at the device 110 to perform any one or more of the techniques described herein.

At a block 312, the method 300 may include utilizing the trained ML model to identify one or more other wearable items based on a particular wearable item which is virtually tried-on by the user. For example, an indication of the user 112 and of the wearable item 140 may be input into the trained ML model 132, and the trained ML model 132 may operate on the inputs to generate an output indicative of one or more other wearable items which are suggested or recommended to the user 112 as a substitution or as addition(s) to the wearable item 140. The other wearable item(s) may have one or more different characteristics than the wearable item 140 (e.g., different size, cut, color, length, model, material, etc.) which may better fit or suit the user 112 (e.g., based on the waypoints of the user's virtual mapping or 3D meshes), the other wearable item may specifically complement the wearable item 140 when worn together by the user 112, and/or the other wearable item may be another wearable item which may be more likely to be purchased by the user 112 in conjunction with the wearable item 140 as compared to other possible wearable items, for example.

In an embodiment, the block 312 may be executed in conjunction with an execution of an instance of the method 200 for customizing or personalizing virtual try on of wearable items, (e.g., at a physical location of or associated with an enterprise which provides the wearable item). In an embodiment, the virtual product adjustment engine 130b may execute the block 312, in some cases, in conjunction with the augmented reality user interface engine 142 and/or in conjunction with the virtual product adjustment engine 130a. For example, after the presentation of an AR representation of the wearable item 140 on one or more images of the user (block 215), another wearable item which has been optimally determined for the user 112 based on the wearable item 140 may be determined by the trained ML model (block 312) and presented on user interface 138b (e.g., as an addition to the wearable item 140, a substitute, a recommendation, a suggestion, etc.) for the user's consideration. Upon consideration, the user 112 may instruct, via the user interface 138b and augmented reality user interface engine 142, the system 100 to present an AR representation of the other wearable item on the one or more images of the user 112, e.g., in conjunction with the presentation of the AR representation of the wearable item 140 or instead of the presentation of the AR representation of the wearable item 140. The augmented reality integration engine 128b may generate the requested AR representation of the other wearable item and present the AR representation on the one or more images of the user 112, e.g., at the user interface 138b.

At a block 315, the method 300 may include updating the user's historical data based on user behavior with respect to the particular wearable item 140 and the associated wearable items indicated by the ML model 132. For example, upon completion of an execution of an instance of the method 200 for customizing or personalizing virtual try on of wearable items, (e.g., at a physical location of or associated with an enterprise which provides the wearable item), the system 100 may record or log, e.g., in the user profile 150 of the user 112, data indicative of, generated by, and/or otherwise corresponding to the execution of the instance of the method 200 and data indicative of subsequent behavior of the user 112, such as virtually-trying on another wearable item, either as an alternative or in addition to the wearable item 140, characteristics of the another wearable item, user input, preferences, and feedback to the system 100, purchases, exchanges, returns, etc. Further, if new or updated virtual depictions of the wearable item 140 and/or of any subsequently indicated wearable items were generated, such new or updated virtual depictions may be stored in the virtual depiction data store 148.

At a block 318, the method 300 may include utilizing the updated historical data to re-train the ML model, such as by using the techniques discussed above with respect to the block 305 and elsewhere herein.

At a block 320, the method 300 may include utilizing the re-trained ML model to identify one or more other wearable items based on another particular wearable item which is virtually tried on by the user 112. For example, the re-trained ML model may be utilized in conjunction with an execution of another instance of the block 312, in some cases, with an execution of another instance of the method 200 with respect to user 112.

### Additional Considerations

The present disclosure generally describes detecting a physical presence of a wearable item in a physical location associated with an enterprise or a retailer. However, any of the techniques herein may be easily applied to detecting a virtual presence of a wearable item in a virtual location associated with an enterprise or a retailer. For example, the systems and/or the methods described herein may detect a virtual presence of a wearable item in a digital image or description, video, movie, live stream, video game, virtual reality environment, augmented reality environment, etc., and may utilize any one or more of the techniques utilized herein to customize and/or personalize virtual try-on of the detected wearable item on a subject person.

Further, the following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Additionally, the memories 125a and 125b may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memories 125a and 125b may include instructions for carrying out any of the steps of the methods described herein via an algorithm executing on the processors 120a and/or 120b. It should be appreciated that one or more other applications may be envisioned and that are executed by the processor(s) 120a and 120b. It should be appreciated that given the state of advancements of mobile computing devices, any or all of the processes functions and steps described herein may be present together on a mobile computing device, such as the local computing device 110.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for customized and/or personalized virtual try-on of wearable items, and/or systems, methods, and/or techniques associated therewith. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An augmented reality (AR) system, comprising:
one or more sensors disposed at a physical enterprise location;
one or more processors; and
one or more non-transitory memories coupled to the one or more processors and storing computer-executable instructions that, when executed by the one or more processors, cause the AR system to:
detect, via the one or more sensors, an indication of a physical presence of a wearable item at the physical enterprise location;
based on the detection, obtain a virtual depiction of the wearable item;
obtain a virtual mapping of at least a portion of an appearance of a user;
assign one or more waypoints of a plurality of waypoints of the virtual depiction of the wearable item to respective waypoints of a plurality of waypoints of the virtual mapping corresponding to the user;
based on the assignment, generate an AR representation of the wearable item on the user; and
present, at a display disposed at the physical enterprise location, the AR representation on one or more images of the user.

2. The AR system of claim 1, wherein the computer-executable instructions, when executed by the one or more processors, cause the AR system further to:
receive, via a user interface, input data indicative of an adjustment to the AR representation, the adjustment to the AR representation including an adjustment of at least one of: (i) a color of the wearable item, (ii) a size of the wearable item, (iii) a virtual depiction change, (iv) a material of the wearable item, or (v) a characteristic of the appearance of the user;
generate an adjusted AR representation based upon the input data; and
present, at the display, the adjusted AR representation on the one or more images of the user.

3. The AR system of claim 1,
further comprising a virtual depictions data store storing respective virtual depictions of a plurality of wearable items, the wearable item included in the plurality of wearable items; and
wherein the virtual depiction of the wearable item is obtained from the virtual depictions data store.

4. The AR system of claim 1, wherein the virtual mapping corresponding to the user is obtained from a virtual mappings data store storing a plurality of virtual mappings of a plurality of users, the user included in the plurality of users.

5. The AR system of claim 4, further comprising the virtual mappings data store.

6. The AR system of claim 1, wherein the virtual mapping corresponding to the user is generated based upon appearance data of the user.

7. The AR system of claim 6, wherein:
at least a portion of the appearance data of the user is based on data provided by the one or more sensors disposed at the physical enterprise location; and
the computer-executable instructions, when executed by the one or more processors, cause the AR system further to generate, via an execution of at least one machine learning algorithm, the virtual mapping corresponding to the user based on the data provided by the one or more sensors.

8. The AR system of claim 1, wherein:
the computer-executable instructions, when executed by the one or more processors, cause the AR system further to determine, based upon a user data set indicative of at least one of preferences or behaviors of the user, one or more wearable items that correspond to the at least one of preferences or behaviors of the user;
the wearable item is included in the one or more wearable items; and
the obtaining of the virtual depiction of the wearable item is responsive to a user selection of the wearable item.

9. The AR system of claim 1, wherein the one or more images of the user include at least one of:
a dynamic image of the user, and wherein the presentation of the AR representation on the dynamic image of the user is a dynamic presentation;
a two-dimensional image of the user; or
a three-dimensional image of the user.

10. The AR system of claim 1, wherein the one or more sensors include an image processor.

11. The AR system of claim 1, wherein at least a portion of the one or more processors and at least a portion of the computer-executable instructions are included in a personal electronic device (PED) operated by the user.

12. The AR system of claim 11, wherein at least one of: the display or at least a portion of the one or more sensors is included in the PED operated by the user.

13. The AR system of claim 1, wherein the display is included in a smart mirror disposed at the physical enterprise location.

14. A method at an augmented reality (AR) system, the method comprising:
detecting, via one or more sensors disposed at a physical enterprise location and by one or more processors of the AR system, an indication of a physical presence of a wearable item;
responsive to the detecting, obtaining, by the one or more processors, a virtual depiction of the wearable item;
obtaining, by the one or more processors, a virtual mapping of at least a portion of an appearance of a user;
assigning, by the one or more processors, one or more waypoints of a plurality of waypoints of the virtual depiction of the wearable item to respective waypoints of a plurality of waypoints of the virtual mapping corresponding to the user;
generating, based on the assigning and by the one or more processors, an AR representation of the wearable item on the user; and
presenting, at a display disposed at the physical enterprise location and by the one or more processors, the AR representation on one or more images of the user.

15. The method of claim 14, further comprising:
receiving, via a user interface, an indication of an adjustment to the AR representation, the adjustment including a change to at least one of: (i) a color of the wearable item, (ii) a size of the wearable item, (iii) a virtual depiction change, (iv) a material of the wearable item, (v) another characteristic of the wearable item, or (vi) a characteristic of the appearance of the user;
generating, based on the receiving of the adjustment, an adjusted AR representation; and
presenting, at the display, the adjusted AR representation on the one or more images of the user.

16. The method of claim 14, wherein the virtual depiction of the wearable item is a first virtual depiction of a first wearable item, the AR representation is a first AR representation, and the method further comprises:
receiving, via a user interface, an indication of of a second wearable item;
obtaining, based on the indication of the second wearable item, a second virtual depiction of the second wearable item;
generating, based on a plurality of waypoints included in the second virtual depiction of the second wearable item and the plurality of waypoints included in the virtual mapping corresponding to the user, a second AR representation of the second wearable item on the user; and
presenting, at the display or on another display, the second AR representation on the one or more images of the user.

17. The method of claim 14, wherein at least one of:
the obtaining of the virtual depiction of the wearable item includes obtaining the virtual depiction of the wearable item from a first data store storing respective virtual depictions of a plurality of wearable items, the wearable item included in the plurality of wearable items; or
the obtaining of the virtual mapping corresponding to the at least the portion of the appearance of the user includes obtaining the virtual mapping corresponding to the at least the portion of the appearance of the user from a second data store storing a plurality of virtual mappings of a plurality of users, the user included in the plurality of users.

18. The method of claim 14, wherein:
the obtaining of the virtual mapping of the at least the portion of the appearance of the user includes generating at least a part of the virtual mapping corresponding to the user based on appearance data of the user; and
at least one of:
at least a portion of the appearance data of the user is based on data provided by the one or more sensors disposed at the physical enterprise location; or
the generating of the at least the part of the virtual mapping corresponding the user includes utilizing one or more machine learning algorithms.

19. The method of claim 14, wherein:
the method further comprises obtaining a user selection of the wearable item from among a plurality of wearable items; and
the obtaining of the virtual depiction of the wearable item is responsive to the obtaining of the user selection.

20. The method of claim 19, further comprising determining, by the one or more processors, the plurality of wearable items based on a user data set indicative of at least one of preferences or behaviors of the user.
